(19) United States
(12) Patent Application Publication
(10) Pub. No.: US 2008/0033997 A1
(43) Pub. Date: Feb. 7, 2008

(54) Transformation tool for migration of web-based content to portal

(75) Inventor: Ran Banker, Kfar Saba (IL)

Correspondence Address: ABELMAN, FRAYNE & SCHWAB, 666 THIRD AVENUE, 10TH FLOOR, NEW YORK, NY, 10017, US

(73) Assignee: SAP Portals (Israel) Ltd.

(21) Appl. No.: 11/499,790

(22) Filed: Aug. 4, 2006

(51) Int. Cl. G06F 17/00

(52) U.S. Cl. 707/104.1

(57) ABSTRACT

A transformation tool is provided to web designers and developers, allowing the output of conventional web development and design tools to be applied to a wide range of portal components. As a result, web designers and developers are enabled to reuse, redefine, rename, and remold portal facilities to create new types of content and content arrangements in the enterprise portal. The transformation tool extends the web development environment so as to expose the capabilities of the enterprise portal technology and provide scalability to enhance the use and display of the content.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### REFERENCE TO COMPUTER PROGRAM LISTING APPENDIX

A Computer Program Listing Appendix is submitted herewith on one compact disc and one duplicate compact disc. The total number of compact discs including duplicates is two. The file on the compact disc is an ASCII text file. Their names, dates of creation, directory locations, and sizes in bytes are:

The root folder contains the file 57407LST.TXT (which include Listing 1 through and including Listing 8, referred to hereinbelow) of Jul. 13, 2006 and of length 9,745 bytes.

The files are referred to herein as the Appendix. The material on the compact discs is incorporated by reference herein.

### BACKGROUND OF THE INVENTION

1. Field of the Invention

This invention relates to networked portal systems. More particularly, this invention relates to transformation of web-based content to portal content in a portal system.

2. Description of the Related Art

TABLE 1
Acronyms, Abbreviations, and Terminology

| | |
|---|---|
| API | Application Programming Interface |
| CSS | Cascading Style Sheet |
| GC | Generic Creator |
| HTML | Hypertext Markup Language |
| HTTP | Hypertext Transfer Protocol |
| J2EE | Java 2 Enterprise Edition |
| JCA | J2EE Connector Architecture |
| JDK | Java Development Kit |
| JSP | Java Server Page |
| JSWDK | Java Server Web Development Kit |
| KM | Knowledge Management |
| OBN | Object Based Navigation |
| PAR | Packed Portlet Archive |
| PCD | Portal Content Directory |
| PRT | Portal Runtime Technology |
| WSRP | Web Services for Remote Portlets |
| XML | Extensible Markup Language |

Portal-based network environments have become increasingly important, particularly in large enterprises having a diversity of computer systems. For example, such environments can now be implemented using SAP NetWeaver® portal technology, available from SAP AG, Neurottstraβe 16, 69190 Waldorf, Germany. This technology supports integration and application platform requirements, and facilitates the development, deployment, and administration of enterprise services. NetWeaver portal technology uses specialized browser portlets, called “iViews”, to incorporate essentially any kind of application, information or service that can be rendered in a Web browser frame. NetWeaver portal technology also provides users with a capability of navigating among iViews using a web browser, and thereby obtaining coherent, portal-based views of enterprise data. Additionally, NetWeaver portal technology facilitates the creation of new computer-implemented services for the enterprise.

### SUMMARY OF THE INVENTION

Web site content creation and conversion display in enterprise portals is difficult, and the facilities currently offered are limited and rather user-unfriendly. In order to maintain web content on the portal, web designers and developers are required to be knowledgeable about programming languages and development environments, e.g., NetWeaver Studio, available from SAP. In order to make use of portal functionalities such as navigation technologies, server side scripting, and basic semantics, developers and designers have to become involved in low level code. Consequently, the portal framework is not readily utilized to create free style layout, expose navigation hierarchies, create free style look and feel, and create lightweight portals in an intuitive way.

According to embodiments of the invention, a transformation tool is provided, allowing the output of conventional web development and design tools to be applied to a wide range of portal components without requiring an in depth knowledge of the portal environment. Using the tool, web designers and developers are enabled to create, redefine, and recycle semantic entities for use with portal facilities when creating content arrangements and developing new types of content in the enterprise portal. The transformation tool extends the web development environment to expose the capabilities of the enterprise portal technology and facilitates scalability in the use of the portal.

An embodiment of the invention provides a computer-implemented method for automatically transforming markup language output of a web development tool into a portal application, which, when executed, establishes or modifies a portal. The portal is an interface to a plurality of content sources and software applications and is viewable by a user thereof. The method is carried out by parsing the markup language output to yield a parsed output, assembling the parsed output and resources into an archive. The parsed output and the resources are required to construct a portal application. The method is further carried out by generating the portal application from the archive, wherein execution of the portal application.

According to an aspect of the method, the archive is deployed into a portal repository.

An additional aspect of the method includes analyzing contents of the portal repository to identify features of interest therein, and compiling statistics respecting the features.

Still another aspect of the method includes deriving new objects from the source objects in the portal repository, wherein the new objects inherit attributes of the source objects and are linked to the source objects by delta links, and wherein modifications of the source objects are propagated to the new objects according to the delta links.

Yet another aspect of the method includes deriving a portal semantic object from the portal application, and creating initial content for the portal semantic object.

A further aspect of the method includes deploying the portal semantic object and the initial content to a portal for display thereof.

Still another aspect of the method includes incorporating the portal semantic object in a portal iView.

An additional aspect of the method includes incorporating navigation display information the portal semantic object.

The markup language output can be a HTML page, a JSP page, or a portal layout.

One aspect of the method includes generating a portal page from the portal layout.

According to yet another aspect of the method, the parsed output is a JSP file.

An embodiment of the invention provides a computer software product for automatically transforming markup language output of a web development tool, including a tangible computer-readable medium in which computer program instructions are stored, which instructions when read by a computer, cause the computer to parse the markup language output to yield a parsed output, assemble the parsed output and resources into an archive. The parsed output and the resources is required to construct a portal application, and generate the portal application from the archive.

An embodiment of the invention provides a computer-implemented portal system, including a server, and a portal for linking a plurality of client browsers with the server. The server executes portal runtime software, which includes a transformation tool for automatically transforming markup language output of a web development tool into a portal application. The transformation tool operative for parsing the markup language output to yield a parsed output, assembling the parsed output and resources into an archive, and generating the portal application from the archive. When executed the portal application establishes or modifies the portal.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a high level block diagram illustrating a portal system having a transformation tool in accordance with a disclosed embodiment of the invention;

FIG. 2 is a detailed block diagram of the transformation tool shown in FIG. 1, in accordance with a disclosed embodiment of the invention;

FIG. 3 is a high level flow chart of a method of creating portal semantic objects from web-based content in accordance with a disclosed embodiment of the invention;

FIG. 4 is a diagram, which illustrates the conversion of a HTML into a JSP file in accordance with a disclosed embodiment of the invention;

FIG. 5 is a diagram of the directory structure of a PAR file in accordance with a disclosed embodiment of the invention;

FIG. 6 is a fragmentary diagram of the directory structure of the PAR file shown in FIG. 5, in accordance with a disclosed embodiment of the invention;

FIG. 7 is a fragmentary diagram of an exemplary directory structure of a PAR file, illustrating copying of local resources from an iView, in accordance with a disclosed embodiment of the invention;

FIG. 8 is a fragmentary diagram of the directory structure of the PAR file shown in FIG. 5, illustrating the incorporation of internal classes into a private area of a deployment descriptor subdirectory in accordance with a disclosed embodiment of the invention; and

FIG. 9 is a pictorial diagram illustrating the creation of two different role views of a portal, in accordance with a disclosed embodiment of the invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code, which embodies aspects of the present invention, is typically maintained in permanent storage, such as a computer readable medium. In a client-server environment, such software programming code may be stored on a client or a server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications network, such as the Internet. In addition, while the invention may be embodied in computer software, the functions necessary to implement the invention may alternatively be embodied in part or in whole using hardware components such as application-specific integrated circuits or other hardware, or some combination of hardware components and software.

### Overview.

In computer systems, a network service that offers a central user access point or interface viewable using a browser, to multiple sources of content and, applications in an enterprise, which is termed a “portal”. Organizations deploy portal servers to build and maintain portals for interaction with end users. By centralizing access to information in this way, multiple user interfaces to different computer systems and applications can be eliminated. Such portals facilitate collaboration and knowledge sharing within an enterprise. Other benefits of portal use include reduction in redundancy of work, e.g., multiple user interactions to make entries and undertake searches for information in different database systems, and time savings through content aggregation.

“Portal applications” are complex and specialized software for developing, establishing and maintaining such portals. The requirements for portal applications are stringent. The portals they create must be compliant with the often changing requirements of diverse information systems and resources which the portal exposes to the user. In an enterprise, users often have different roles, which differentiate the information to be offered by the portal. Assuring that the portal established by a portal application supports multiple roles, their privileges and information needs is yet another requirement of a competent portal application. Aspects of the invention deal with transforming web-based content into a form acceptable for use in a portal for use by a portal application.

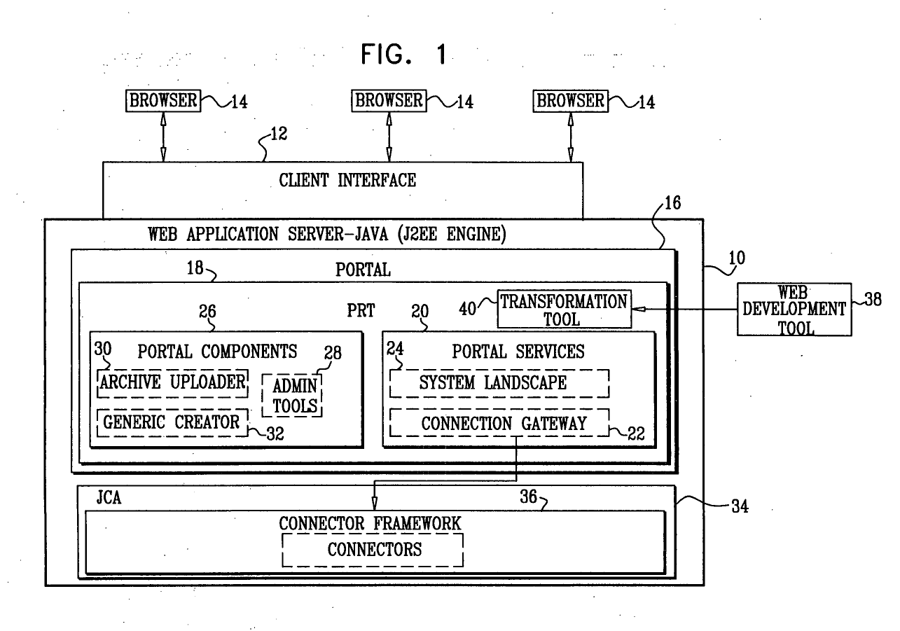

Turning now to the drawings, reference is initially made to FIG. 1, which is a high level block diagram illustrating a portal system having a transformation tool in accordance with a disclosed embodiment of the invention. A web application server 10 is accessed over a data network, e.g., the Internet or a private intranet, via a client interface 12 by any number of clients or end users, each of who has a browser 14. The server 10 is typically realized as a computer that includes a processor and a memory that contains objects corresponding to functional blocks depicted in the drawings herein. Thus, although the server 10 is shown in FIG. 1 as comprising a number of separate functional blocks, these blocks are not necessarily separate physical entities, but rather may represent different computing tasks. These tasks may be carried out in software running on a single processor, or on multiple processors. The software may be provided to the processor or processors in electronic form, for example, over a network, or it may be furnished on tangible media, such as CD-ROM or non-volatile memory. Alternatively or additionally, aspects of the server 10 may comprise a digital signal processor or hard-wired logic.

In current embodiments, the server 10 operates under a platform-independent execution environment, J2EE under the Java™ platform, both available from Sun Microsystems Inc., Palo Alto, Calif. However, the principles of the invention may be applied to other platforms and execution environments by effecting suitable modifications within the capabilities of those skilled in the art.

The server 10 supports a portal system 16 that includes a number of portal runtime modules 18, collectively referred to as “Portal Runtime Technology” (PRT). The portal system 16 can be realized using the above-noted NetWeaver Portal Technology.

In general the portal runtime modules 18 supply various services to portal users, management, and security. The portal runtime modules-18 include general portal services 20, which include a connector gateway 22, and a system landscape portal service 24. The system landscape portal service 24 is a block representing a logical, complex system, which can consist of multiple, distributed components. Some of these components may themselves be systems. Others may be services, installed products, or other managed elements. Furthermore, any of the components of the system landscape portal service 24 can be third party components, to which there is a need for seamless access and communication. The connector gateway 22 is a service that enables a connection between the portal system 16 and one or more external information systems (not shown), using the system landscape portal service 24.

Among the portal runtime modules 18 are a group of portal components 26, which provide various administrative tools 28 required for portal administration and operation. In particular, the portal runtime modules 18 includes an archive uploader 30 to upload a packed portlet archive (PAR) to a portal application repository (also known as a portal content directory (PCD)) and to create a semantic object from a portal application using a generic semantic object creation module 32. The archive uploader 30 and the semantic object creation module 32 are described in further detail below.

J2EE provides a connector architecture 34, known as the “J2EE Connector Architecture” (JCA), which defines a standard scalable architecture for connecting the J2EE platform to heterogeneous external information systems. The connector architecture 34 is extended in the portal system 16 by a connector framework 36, which consists of interfaces described by the JCA specification and extensions defined by the connector framework 36.

A generic web development tool 38 is used to supply at least a portion of video content to the portal system 16. The web design and development tool Dreamweaver® 8, available from Adobe Systems Incorporated, 345 Park Avenue, San Jose, Calif. 95110-2704, is suitable for the web development tool 38.

Graphical material designed using the web development tool 38 is normally emitted as a stream or document written in a markup language, e.g., XML, HTML or a JSP page. Such a document may be suitable for display and processing using a web browser. However, in this form, it cannot be generally deployed directly to the portal system 16. According to aspects of the invention, the output of the web development tool 38 is converted by a transformation tool 40 into a form that is acceptable by the facilities of the portal system 16, as if it were native portal source material. As a result, a developer is enabled to use the web development tool 38 to create free style layout in the context of a regular portal or even a lightweight portal that has a relatively small code size, in an easy and intuitive way.

### Transformation Tool.

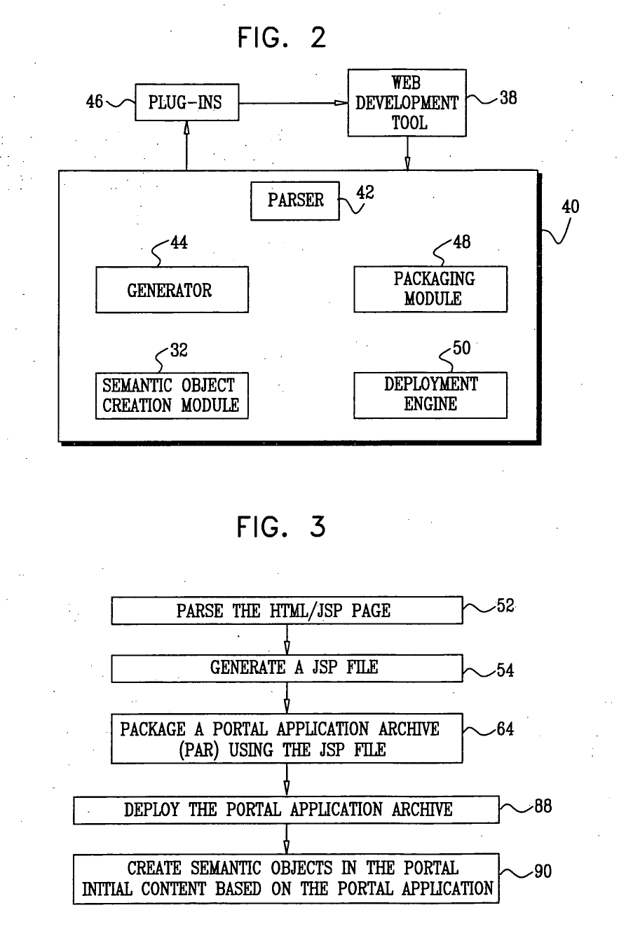

Reference is now made to FIG. 2, which is a detailed block diagram of the transformation tool 40 (FIG. 1), in accordance with a disclosed embodiment of the invention. The transformation tool 40 contains a number of functional blocks, which are typically implemented as one or more software libraries. The transformation tool 40 can be integral in the portal system 16, e.g., in the portal runtime modules 18 (FIG. 1), or can be an independent module that is linked to the portal system 16, in which case the transformation tool 40 can access facilities of the portal system 16 as required. While the transformation tool 40 is shown as a separate unit in FIG. 2 for clarity of presentation, operation of functional blocks shown in FIG. 2 may actually involve accesses in whole or in part by the transformation tool 40 from libraries or other facilities of the portal system 16.

A parser 42 typically receives input from the web development tool 38. The input is usually a HTML or JSP page. The parser 42 converts the input into a source code, e.g., Java source code. The parser 42 is conventional. For example, the Java Server Web Development Kit (JSWDK) provides a parser that is suitable for use as the parser 42. This can be used in conjunction with the JDK Regular Expression support package to identify patterns in the source file, both available from Sun Microsystems, Inc., Palo Alto, Calif.

A generator 44 accepts source code from the parser 42 and compiles it into a design view, acceptable to the development tool being used, e.g., a JSP file. The particular format chosen is application dependent. The transformation tool 40 provides plug-ins 46 to the web development tool 38, e.g., an iView container for generating a page or layout and for rendering navigation links in iViews. While source files are typically JSP files, this is not essential. However, web designer tools generally support JSP files. Thus, any JSP tags that may be added by the generator 44 may be conveniently previewed using the facilities of the web development tool 38. Java compilers and code generators are well known in the art, and many are suitable for use as the generator 44.

The JSP file produced by the generator 44 is incorporated by a packaging module 48 into an archive file. In one aspect of the invention, the archive file is suitable for creation of a portal application, e.g., a portlet. In current embodiments the portal application is an iView. Portlets are Java-based pluggable user-interface components, which are managed by a portlet container. Portlets provide a presentation layer in order to process requests and generate dynamic content. In current embodiments, the archive file is a PAR file, which can contain many types of data, e.g., pages, layouts. A PAR file contains the files needed in order to for the transformation tool 40 to deploy a portlet into a portal application repository. In particular, the PAR file contains the content and descriptor that describes the portal application. Clients with sufficient privileges would eventually use the portlet as part of an iView, following completion of additional steps described below.

The transformation tool 40 utilizes the semantic object creation module 32 (FIG. 1), which is a specialized module that accesses the archive produced by the packaging module 48 and creates semantic objects, i.e., collections of attributes that represent portal objects, such as iViews, pages or layouts.

A deployment engine 50, which is a standard feature of the portal system 16, is used to actually deploy the portlet to the portal application repository. The deployment now includes semantic objects derived from the visual content received from the web development tool 38 (FIG. 1), but specialized according to the requirements of a particular portal. The deployment engine 50 typically utilizes the archive uploader 30 (FIG. 1), which is a specialized archive uploader tool, available from SAP. Alternatively, the deployment engine 50 could be the J2EE deployment engine.

### Operation.

### Parsing and JSP File Creation.

Reference is now made to FIG. 3, which is a high level flow chart of a method of creating portal semantic objects from web-based content in accordance with a disclosed embodiment of the invention. The steps described below are typically performed by the transformation tool 40 (FIG. 2). At initial step 52, a XML, HTML or JSP page or other markup language document or stream is parsed.

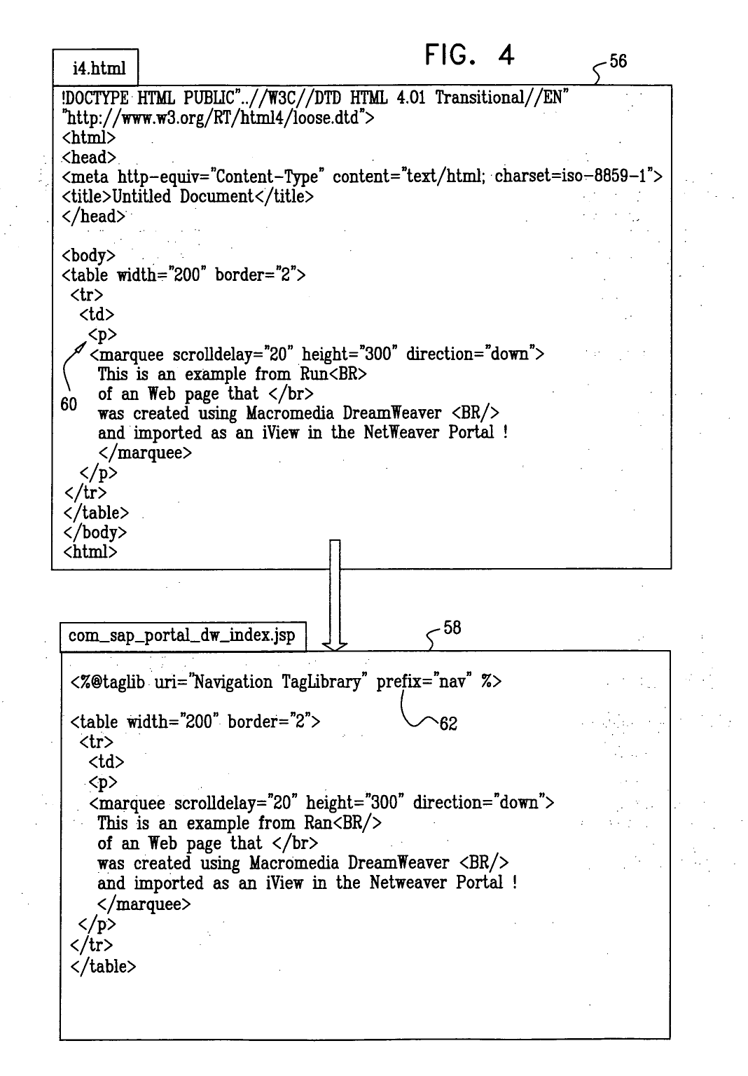

Next, at step 54, the parsed output is used to generate a source code file that can be dynamically compiled into applications, e.g., servlets or portlets. Preferably, this file is a JSP file. Reference is now made to FIG. 4, which illustrates the conversion of a HTML file 56 (i4.html) into a JSP file 58 (com_sap_portal_dw_index.jsp), in accordance with a disclosed embodiment of the invention. The newly created JSP file 58 includes an entire segment of the HTML file 56, which was located in a block 60 (delimited by <body> . . . </body>). Specialized headers can be included in the JSP file. For example, the JSP file 58 contains a proprietary JSP header 62.

### Packaging a PAR File.

Referring again to FIG. 3, next, at step 64, the file produced in step 54 is incorporated in a PAR file, which has a specific data structure. This is done in a sequence of stages, which may be performed in many different orders.

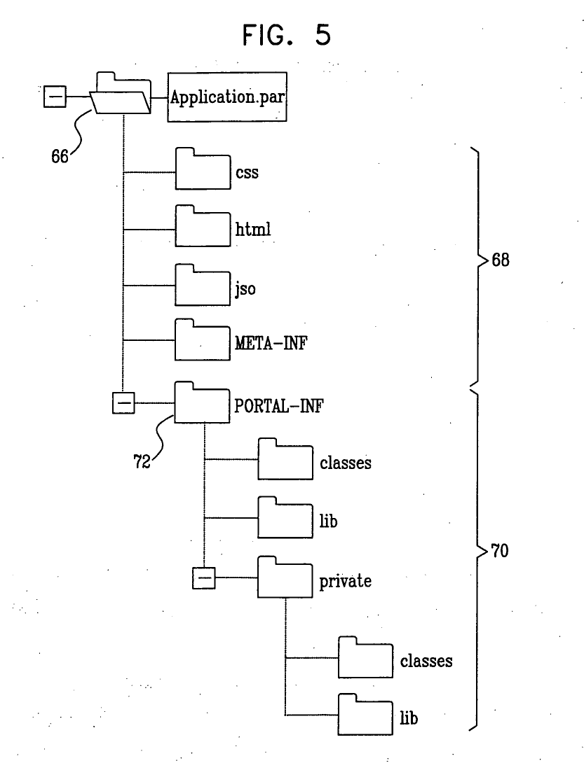

Reference is now made to FIG. 5, which is a diagram of the directory structure of an exemplary PAR file 66 (Application.par), in accordance with a disclosed embodiment of the invention. The PAR file 66 may include any-number of different types of resources 68, e.g., Web resources, which can occur in various combinations. The PAR file 66 also includes several other types of resources, among which are non-Web resources 70, including a deployment descriptor subdirectory 72 (portal-inf) Preparation of the PAR file 66 in step 64 (FIG. 3) includes copying all resources that are located in the source web page, and creation of a descriptor of the PAR file 66 (portalapp.xml). Preparation of the PAR file 66 also includes insertion of internal implementation classes, JAR's, CSS's, and referenced JSP's. Local resources that are located in the source web page, e.g., images, are also copied and included in the PAR file 66 (FIG. 3). All of these activities are performed automatically, and without substantial intervention by a human operator.

Reference is now made to FIG. 6, which is a fragmentary diagram of the directory structure of the PAR file 66 (FIG. 5) in accordance with a disclosed embodiment of the invention, illustrating the incorporation of the JSP file 58 (FIG. 4) into the deployment descriptor subdirectory 72 during step 54 (FIG. 3). A PAR file descriptor 74 (portalapp.xml) has also been incorporated into the deployment descriptor subdirectory 72. At this stage, implementation classes have not yet been included in the directory.

The PAR file descriptor 74, portalapp.xml, also termed a “portal application descriptor”, provides metadata about a specific portal component, e.g., a dependency on other portal components, user role privileges for access to the application. An example of the PAR file descriptor 74 is given in Listing 1.

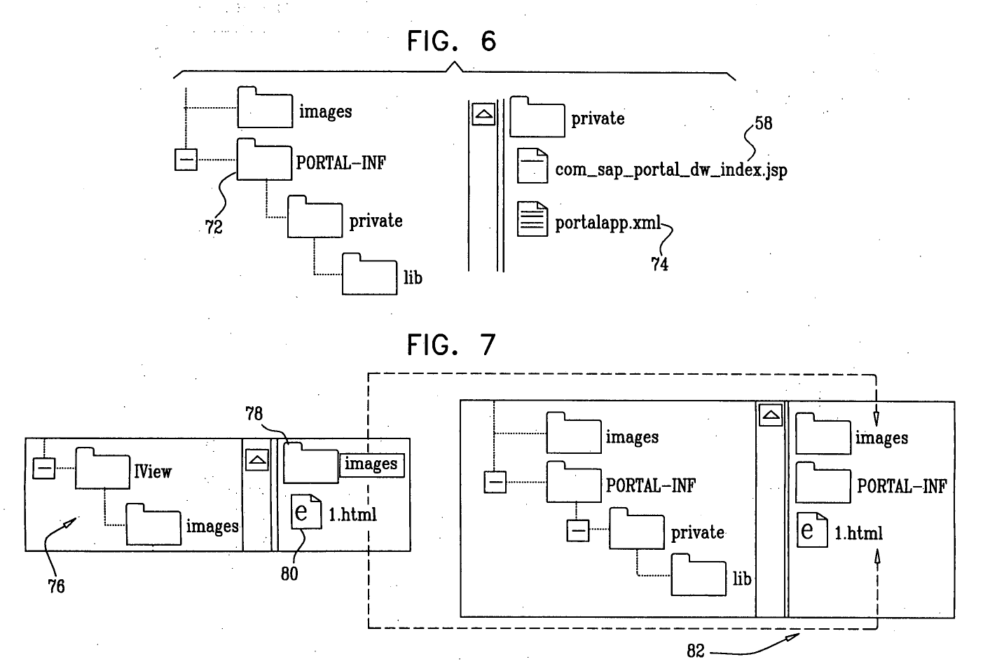

Reference is now made to FIG. 7, which is a fragmentary diagram of an exemplary directory structure of a PAR file in accordance with a disclosed embodiment of the invention, illustrating copying of local resources from an iView, indicated by a directory fragment 76. The resources are located in the source Web page. In this example, image resources 78 and a HTML file 80 are copied and included in the PAR file 66, which is shown in a directory fragment 82 at the right of FIG. 7.

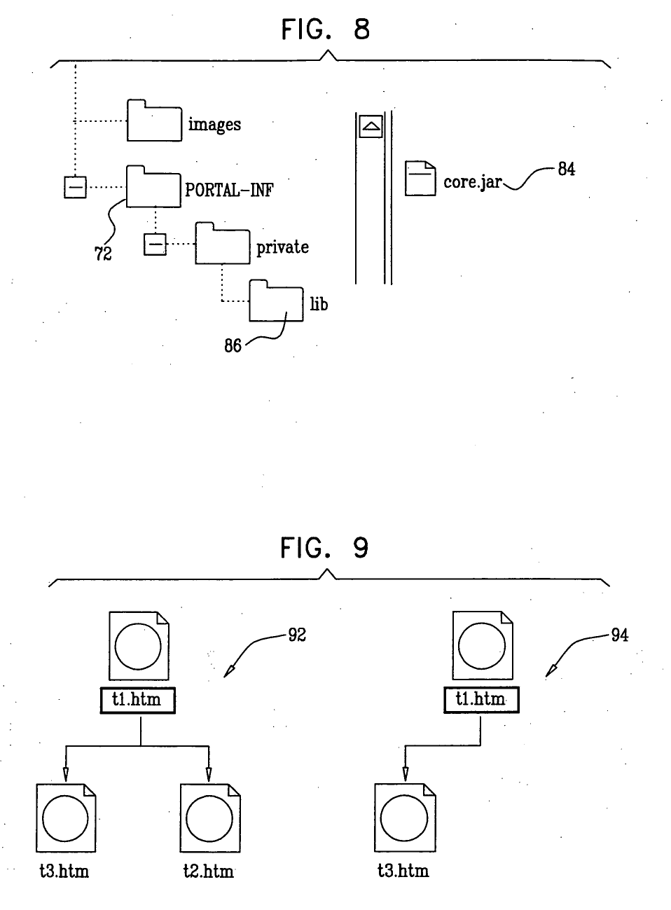

Reference is now made to FIG. 8, which is a fragmentary diagram of the directory structure of the PAR file 66 (FIG. 5) illustrating the incorporation of internal classes into a private area of the deployment descriptor subdirectory 72 during step 64 (FIG. 3), in accordance with a disclosed embodiment of the invention. A JAR file 84 (core.jar) has been placed into a subdirectory lib 86 (PORTAL-INF/private/lib). The JAR file 84 contains a portal component “GenericDWContentBuilder” and several other utility classes. This portal component is responsible for actually rendering the portal iView on a browser. The class extends a base class AbstractPortalComponent, documentation of which is available from SAP, or via the Internet at the URL. “https://media.sdn.sap.com/javadocs/NW04/SPS15/ep/index.html.” This class includes a method “doContent”, which generates the content of the component, e.g., the actual rendering instructions for the iView. The generated JSP file 58 (FIG. 6) is included, as shown in an example in Listing 2. Execution of the JSP file 58 by an iView renders the generated JSP content and produces a HTML markup when the portal application is executed.

### Creation of a Portal Application from a PAR File.

Referring again to FIG. 3, at step 88, the portal application archive created in step 64 is deployed. The details are as follows.

The PAR file is uploaded to the portal application repository, typically via HTTP. The archive uploader 30 (FIG. 1) is responsible for upload of portal applications by addressing a HTTP request to the portal URL, for example:

http://<host>:<port_number>/
irj/servlet/prt/prtrw/prteventname/upload/
prtroot/com.sap.portal.runtime.system.
console.ArchiveUploader?

Several HTTP parameters are concatenated to the above URL:
j_user—the portal user name of the system administrator, which is authorized to upload content; and
j_password—the portal user password.

A full list of properties is as follows:

j_user=<user_name>&j_password=<user_password>&login_submit=
on&j_authscheme=default&uidPasswordLogon=Log%20on.

After having been uploaded by the archive uploader 30 into the portal application repository, the PAR file can be used later to create new content, e.g., iView pages.

The portal has a number of tools for managing the portal application and for creating content. For example, a permissions editor is used to assign user, group and role permissions to portal objects. More specifically, using the permission editor, one can define permissions various objects, e.g., business objects and operations, folders and portal components, and portal objects, such as iViews, portal pages, layouts, roles, worksets, packages and systems. The permission editor recognizes security zones and safety levels used to authorize direct URL access to portal components and services.

In current embodiments, creation of iView pages and layouts is performed automatically by the transformation tool 40 (FIG. 2). Optionally, a series of iView Wizards, available from SAP, provides step-by-step guidance in creating iViews based on iView templates or portal components. These wizards are adapted to particular types of iViews being created.

### Creation of Portal Semantic Objects

Referring again to FIG. 3, at final step 90 portal semantic objects are developed from the deployed portal application, based on the type of portal application. This step is versatile. As noted above, the portal application can comprise an iView, which can include such objects as controls, images, and animations. The application can also be used to facilitate additional portal integration by generating portal layouts, including system templates. Indeed, even the generic system template of the portal components 26 (FIG. 1) can be modified. In a further application of final step 90, content can be migrated from a development system to a production system. By designing various types of links in the portal content, the web development tool 38 (FIG. 2) can create new navigation views in the portal, thereby increasing the utility of the portal system.

The portal has a semantic layer that supports several types of semantic objects, e.g., iViews, pages and layouts. These objects are stored in the portal application repository, and can be accessed using generic Java API's. Some of these semantic objects can be viewed as user interface content in the portal.

The portal features a generic creator (GC) tool, also known as a “content and action upload portal tool”. This is a portal component that simplifies the creation of portal semantic objects using a XML-based script. Among the functions carried out by the GC tool are role assignment of users and groups, and assignment of aliases to portal systems. The GC tool has the ability to run other XML scripts, which are called from a basic XML script. This capability provides a useful looping feature, which enables passing of parameter values and the performance of automated batch replacements.

After the portal component has been deployed using the ArchiveUpload feature, another portal component, _InitialContentRunner, activates the generic creator tool. This component accepts a generic creator script and executes it in the portal environment. An exemplary generic creator script for creating an iView based on the iView portal component is shown in Listing 3. In Listing 3, “GenericCreator” is the root element, which contains some metadata for the script execution, e.g., “Author name”, “Locale”. A number of property constants are used to simplify the script language. For example the statement

Context objectClass=“com.sap.portal.pcd.gl.GlContext” simplifies creation of folders in the portal content catalog. The statement,

Context objectClass=“com.sapportals.portal.iview”
template=“par:/applications/ti1/components/ti1”,

is used to create a semantic object of type iView based on the following deployed portal application:

“par:/applications/ti1/componets/ti1”.

Referring again to FIG. 3, by performing final step 90 in different ways, different viewing environments are created for different categories of users. For content editors, specific read-only system templates (layouts) can be exposed for reuse, with different sets of controls . . . For web developers, it is possible to expose internal portal functionality, e.g., JSP tags, in order to access different tools and facilities of the portal components 26 (FIG. 1). For example, in some embodiments, it is also possible to adapt semantic objects to comply with requirements of a knowledge management (KM) system, to expose its online resources. As a further example, the above-noted Dreamweaver web design and development tool exposes a source control mechanism that can be used in a standalone mode, or integrated with the KM. In yet another application, final step 90 can be performed to adapt the semantic objects so as to create connectivity and expose the facilities of third-party products, thereby enhancing interoperability of the portal system with the products of other vendors.

To conclude final step 90, initial content, based oh the semantic objects, is developed for the portal user interface, which is now ready for deployment to a portal viewable by browsers.

### EXAMPLE 1

In general, as noted above, different role views can be created by varying the performance of final step 90 (FIG. 3). To assist in understanding the advantages of creating different role views, Table 2 shows a group of pre-configured roles available in the NetWeaver portal.

TABLE 2
Pre-Configured Roles

| Target User | Roles |
|---|---|
| Administrators | Super Administrator |
| | Content Administrator |
| | User Administrator |
| | System Administrator |
| | Delegated User Administrator |
| Business Users | Standard User |
| | Every User Core (limited version of |
| | Standard User) |
| | Control Center User |

Reference is now made to FIG. 9, which is a pictorial diagram illustrating the creation of two different role views 92, 94 of a portal, in accordance with a disclosed embodiment of the invention. The role views 92, 94 are OBN navigation views, which typically define the operation of an object. For example, the role views 92, 94 might trigger the display of different business objects. The role view 92 exposes the pages t1.htm, t2.htm, and t3.htm. The role view 94 is more limited, only exposing the pages t1.htm and t3.htm.

### Portal Layouts.

The procedure for creation of a portal layout is similar to that described above with reference to FIG. 3 for the creation of a portal application. A JSP file specifies the layout structure. The entire content between the <BODY></BODY> element of a source JSP file is copied to a new JSP file that contains a predefined header:

```
<%@ taglib
  uri=“prt:taglib:com.sap.portal.reserved.layout.
    TagLibLayout” prefix=“lyt” %>
<lyt:template>
```

The source JSP file should contain JSP elements that will provide a unique ID to each iView that may be created from the layout, e.g.,

<lyt:containerWithTrayDesign
id=“column1”>
</lyt:containerWithTrayDesign>.

### Finally, the JSP file ends with a closing JSP tag, </lyt:template>. An exemplary listing of a new JSP file based on a source JSP file is shown in Listing 4.

An exemplary listing for the descriptor file, portalapp.xml, for a portal layout is shown in Listing 5. The Portal component includes common directions and includes new generated iView containers “column1” and “column2”.

After the portal component has been deployed using ArchiveUpload facility. The portal component _InitialContentRunner activates the generic creator. This component accepts the Generic Creator Script and executes it in the portal environment. An exemplary script for creating the layout is generated based on the Layout portal component, as shown in Listing 6.

The item GenericCreator, property constants and context object classes have the same meaning as given in the discussion of Listing 3. The details are not repeated.

An exemplary layout JSP is presented in Listing 7. When a layout is actually created using the layout of Listing 7, it is the locations of the iView wrappers that are significant, rather than the actual iViews. Eventually, when a page is derived from the source JSP file, these iView locations, and iViews of each iView wrapper, are used to create the actual page.

### Portal Page.

A portal page holds iViews and other pages containing iViews, organized in a portal layout. It, will be recalled that iViews retrieve information from various sources, helping users perform their business functions. Portal pages are one means of assigning the iViews to users and roles, and displaying the information that is retrieved.

Creation of a portal page The procedure of creating a portal page is divided into the steps of:

(1) Creating the layout semantic object as described above; and

(2) Deploying a generic creator script that links between the Layout and iViews to be included in each iView container. An exemplary generic creator script is presented in Listing 8.

The source JSP file is similar to the layout JSP file, with an addition that declares the locations of iViews that may be integrated later in each iView wrapper, e.g., the following statements:

```
<div width=“200” height=“395”
    pcdlocation=
            <the PCD Location of the iView to include>
```

### Scalability Issues.

Referring again to FIG. 2, scalability using the transformation tool 40 is achieved using delta links. A delta link is a relationship between two portal content objects. A link between the two objects, which can be source and target objects, is knows as a delta link. The source object is the object that passes its property values to the target object, the latter being derived from the source object. Thus, changes made to the source object are copied to the target object and are visible there. Changes made to the target object have no effect on the source object.

Content can be extended using delta links. For example, a new iView can be derived from an existing or source iView. The new iView may extend the existing iView, and may be established with new parameters or new values of existing parameters. When the source iView is updated by the transformation tool 40, the changes propagate to the new iView. It will be appreciated that chains of attribute inheritance of any length and complexity can be established among iViews in a portal content directory, in which elements of the chain are linked to other elements by delta links. Delta link tracer tools are available from SAP for determining the position of any iView within a delta link chain, and thereby the details of its inheritances and its dependencies.

### Data Management.

One the portal archive has been stored in a portal repository it forms a database, together with other contents of the portal repository. Searches, using known search techniques, can then be undertaken to identify logical patterns in the source code, and to develop statistics relating to the portal once the content has been generated in the portal. For example, the number of resources employed from the portal may be of importance to management. Similarly, statistics on the types of resources utilized, e.g., types of images being used, utilization of technologies such as flash objects, or utilization of navigation tag libraries.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A computer-implemented method for automatically transforming markup language output of a web development tool, comprising the steps of:
parsing said markup language output to yield a parsed output;
assembling said parsed output and resources into an archive, said parsed output and said resources being required to construct a portal application; and
generating said portal application from said archive, wherein execution of said portal application establishes or modifies a portal, said portal being an interface to a plurality of content sources and software applications and being viewable by a user thereof.

2. The method according to claim 1, wherein generating said portal application comprises deploying said archive into a portal repository.

3. The method according to claim 2, further comprising the steps of:
analyzing contents of said portal repository to identify features of interest therein; and
compiling statistics respecting said features.

4. The method according to claim 2, further comprising the steps of deriving new objects from said resources in said portal repository, wherein said new objects inherit attributes of said resources and are linked to said resources by delta links, and wherein modifications of said resources are propagated to said new objects according to said delta links.

5. The method according to claim 1, further comprising the steps of:
deriving a portal semantic object from said portal application; and
creating initial content for said portal semantic object.

6. The method according to claim 5, further comprising the step of deploying said portal semantic object and said initial content to said portal for display thereof.

7. The method according to claim 5, further comprising the step of incorporating said portal semantic object in a portal iView.

8. The method according to claim 5, further comprising the step of incorporating navigation display information said portal semantic object.

9. The method according to claim 6, wherein said markup language output is a HTML page.

10. The method according to claim 1, wherein said markup language output is a JSP page.

11. The method according to claim 1, wherein said markup language output is a portal layout.

12. The method according to claim 11, further comprising the step of generating a portal page from said portal layout.

13. The method according to claim 1, wherein said parsed output is a JSP file.

14. A computer software product for automatically transforming markup language output of a web development tool, including a tangible computer-readable medium in which computer program instructions are stored, which instructions, when read by a computer, cause the computer to:
parse said markup language output to yield a parsed output;
assemble said parsed output and resources into an archive, said parsed output and said resources being required to construct a portal application; and
generate said portal application from said archive, wherein execution of said portal application establishes or modifies a portal, said portal being an interface to a plurality of content sources and software applications and being viewable by a user thereof.

15. The computer software product according to claim 14, wherein in generating said portal application said computer is further instructed to deploy said archive into a portal repository.

16. The computer software product according to claim 15, wherein said computer is further instructed to:
analyze contents of said portal repository to identify features of interest therein; and
compile statistics respecting said features.

17. The computer software product according to claim 15, wherein said computer is further instructed to derive new objects from said resources in said portal repository, wherein said new objects inherit attributes of said resources and are linked to said by delta links, and wherein modifications of said resources are propagated to said new objects according to said delta links.

18. The computer software product according to claim 14, wherein said computer is further instructed to:
derive a portal semantic object from said portal application; and
create initial content for said portal semantic object.

19. The computer software product according to claim 18, wherein said computer is further instructed to deploy said portal semantic object and said initial content to said portal for display thereof.

20. The computer software product according to claim 18, wherein said computer is further instructed to incorporate said portal semantic object in a portal iView.

21. The computer software product according to claim 18, further comprising the step of incorporating navigation display information said portal semantic object.

22. The computer software product according to claim 19, wherein said markup language output is a HTML page.

23. The computer software product according to claim 14, wherein said markup language output is a JSP page.

24. The computer software product according to claim 14, wherein said markup language output is a portal layout.

25. The computer software product according to claim 24, wherein said computer is further instructed to generate a portal page from said portal layout.

26. The computer software product according to claim 14, wherein said parsed output is a JSP file.

27. A computer-implemented portal system, comprising:
a server; and
a portal for linking a plurality of client browsers with said server,
wherein said server is operative for executing portal runtime software, said runtime software including a transformation tool for automatically transforming markup language output of a web development tool into a portal application, said transformation tool operative for:
parsing said markup language output to yield a parsed output;
assembling said parsed output and resources into an archive, said parsed output and said resources being required to construct said portal application; and
generating said portal application from said archive, wherein execution of said portal application establishes or modifies said portal, said portal being an interface to a plurality of content sources and software applications and being viewable-using said client browsers.

28. The portal system according to claim 27, wherein generating said portal application comprises deploying said archive into a portal repository.

29. The portal system according to claim 28, wherein said transformation tool is operative for deriving new objects from said resources in said portal repository, wherein said new objects inherit attributes of said resources and are linked to said resources by delta links, and wherein modifications of said resources are propagated to said new objects according to said delta links.
